(19) United States
(12) Patent Application Publication
(10) Pub. No.: US 2026/0307448 A1
(43) Pub. Date: Oct. 8, 2026

(54) Automatic Anti-Roll Bar Control System

(71) Applicant: BOMBARDIER RECREATIONAL PRODUCTS INC., Valcourt (CA)

(72) Inventors: William LAMEY, Hanwell (CA); Jeffrey BEST, Hanwell (CA)

(21) Appl. No.: 19/173,162

(22) Filed: Apr. 8, 2025

(51) Int. Cl. B60G 17/018; B60G 17/015; B60G 17/02

(52) U.S. Cl. CPC B60G 17/018; B60G 17/0152; B60G 17/025; B60G 2202/135; B60G 2202/43; B60G 2400/824; B60G 2401/14; B60G 2500/22; B60G 2600/182; B60G 2600/1878; B60G 2800/704

(57) ABSTRACT

Method and system for automatically controlling a stabilization of a vehicle is disclosed. The method includes: receiving, through a video camera of the vehicle, real-time perception data comprising a sequence of image frames representing an environment in a direction of travel of the vehicle; predicting, using a trained inference model, based on the sequence of image frames, a sequence of anti-roll bar system mode predictions for an anti-roll bar system of the vehicle, wherein the anti-roll bar system candidate mode predictions correspond to a set of predefined modes for the anti-roll bar system; determining, based on the sequence of anti-roll bar system mode predictions, an anti-roll bar system mode; and causing the anti-roll bar system mode to be implemented.

### CROSS-REFERENCE TO RELATED APPLICATIONS

This is the first application filed for this disclosure.

### BACKGROUND

As well-known in the art, an anti-roll bar (also referred to as a roll bar, anti-sway bar, sway bar or stabilizer bar) is a part of many wheeled vehicle suspensions which helps to reduce a vehicle's body roll during quick cornering or over road irregularities. It connects opposite (left/right) wheels through short lever arms connected by a torsion spring. The anti-roll bar links the two front suspension units together using an arrangement of a bar mounted across the vehicle (usually anchored to the chassis), a pair of arms, and a pair of links connecting the ends of these arms to the lower suspension arms or lower section of the shock absorbers.

Anti-roll bars that can be controlled during vehicle operation enable the degree to which the anti-roll bar couples wheel supports on the opposite sides of a vehicle to be adjusted to account for different vehicle operating conditions. Existing say bar-control systems that control sway-bar “stiffness” rely on manual control by a driver (e.g., via a dash mounted “on/off” style switch) and/or automated control based on tracking of vehicle operational state data as measured by on-board sensors such as accelerometers, tiltometers, inclinometers and the like.

Manually controlled systems are often impractical as they require driver attention and skill to be used effectively, especially in off-road environments where the operating environment can change frequently, extensively, and at fast speeds. Contemporary automated control systems suffer from the fact that they rely on vehicle properties that are currently being sensed—as such, these systems are reactive rather than proactive.

Accordingly, there is a need for automated systems and methods for proactively selecting appropriate control settings for an anti-bar system based on the upcoming conditions that the vehicle will encounter.

### BRIEF SUMMARY

In example aspects, a computer implemented method for automatically controlling a stabilization of a vehicle is disclosed. The method includes: receiving, through a video camera of the vehicle, real-time perception data comprising a sequence of image frames representing an environment in a direction of travel of the vehicle; predicting, using a trained inference model, based on the sequence of image frames, a sequence of anti-roll bar system mode predictions for an anti-roll bar system of the vehicle, wherein the anti-roll bar system candidate mode predictions correspond to a set of predefined modes for the anti-roll bar system; determining, based on the sequence of anti-roll bar system mode predictions, an anti-roll bar system mode; and causing the anti-roll bar system mode to be implemented.

According to a further example aspect, a vehicle is disclosed that comprises: an anti-roll bar system comprising an anti-roll bar, an electronically controlled link responsive to control signals for implementing anti-roll bar system modes, the anti-roll bar and the electronically controlled link being collectively configured and operatively coupled to the vehicle such that a degree of stiffness applied by the anti-roll bar between opposite side wheel supports of the vehicle is adjustable based on the control signals between a minimal degree of stiffness and a maximum degree of stiffness; a computer system, the computer system being configured for automatically selecting an operating mode of the anti-roll bar system by: receiving, through a video camera of the vehicle, a sequence of image frames representing upcoming terrain in a direction of travel of the vehicle; predicting, using a first fitted inference model, based on the sequence of image frames, a sequence of candidate mode predictions for the anti-roll bar system, wherein the candidate mode predictions correspond to a set of predefined modes for anti-roll bar system, the set of predefined modes including at least a first mode corresponding to the minimal degree of stiffness and a second mode corresponding to the maximum degree of stiffness; determining, based on the sequence of candidate mode predictions, an anti-roll bar system mode; and causing an appropriate control signal to be applied to the electronically controlled link to cause the anti-roll bar system to implement the anti-roll bar system mode.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A schematically illustrates a vehicle to which aspects of the disclosure can be applied.

FIG. 1B is a perspective view of an anti-roll bar system including two controllable damper links coupled to a vehicle, in accordance with an embodiment of the present disclosure.

FIG. 1C is a perspective view of a further example of an anti-roll bar system that includes a mechanical coupling device as an electrically controlled link.

FIG. 2 illustrates block diagrams of examples of systems and subsystems of the vehicle of FIG. 1 in accordance with one embodiment.

FIG. 3 illustrates a block diagram of an Automatic Mode Selector in accordance with one embodiment.

FIG. 4 illustrates a block diagram of a subsystem mode classifier of the Automatic Mode Selector in accordance with one embodiment.

FIG. 5 illustrates a block diagram of a Mode Analyzer of the Automatic Mode Selector in accordance with one embodiment.

FIG. 6 illustrates a block diagram of an alternative example of a Mode Analyzer in accordance with one embodiment.

FIG. 7 illustrates an example computer system in accordance with one embodiment.

FIG. 8 is a schematic diagram illustrating a process for obtaining a training dataset according to example implementations.

### DETAILED DESCRIPTION

The present disclosure describes examples of automatic anti-roll bar control systems for a vehicle. In some examples, as described in greater detail below, an AI-based predictive engine (e.g., a classifier) processes real-time perception data generated by a forward perception system of a vehicle in respect of upcoming surface terrain to proactively determine if an anti-roll bar of the vehicle should be automatically engaged or disengaged to optimize user experience based on upcoming road terrain that the vehicle will encounter within an upcoming time frame (e.g. in next 1-3 seconds). In some configurations, the AI-predictive engine is a dedicated classifier that has been trained based on a training dataset acquired by tracking real-time perception data and roll bar engagement data as an expert driver manually causes an anti-roll bar to engage and disengage.

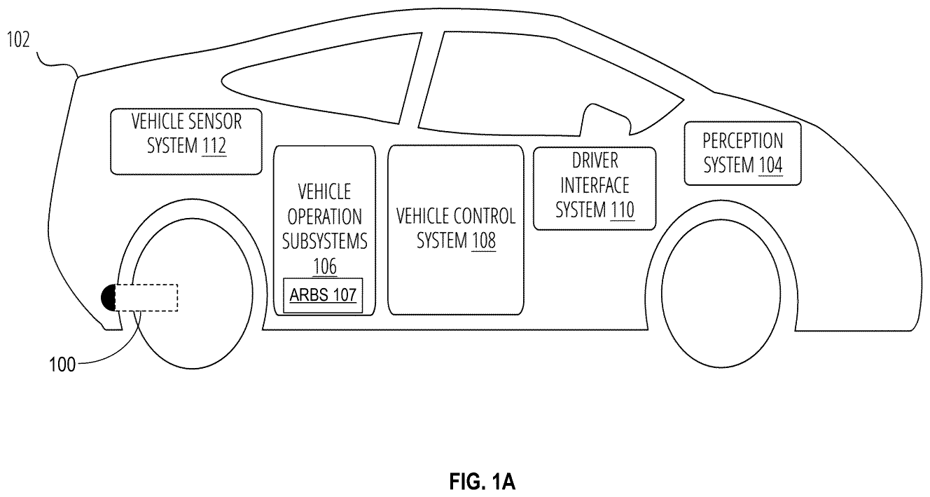

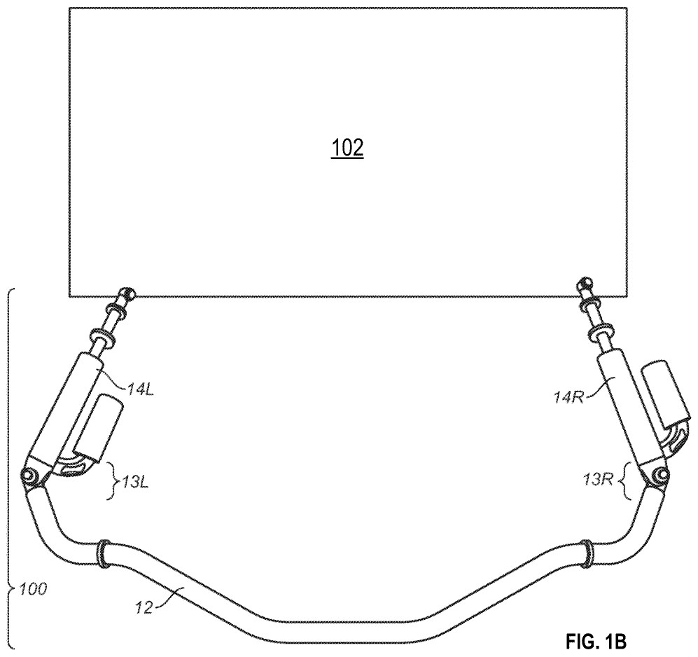

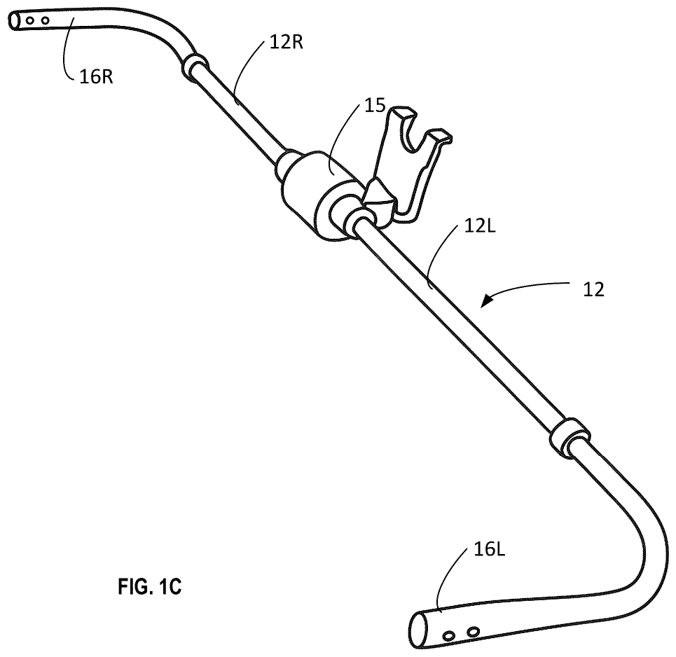

FIG. 1A schematically illustrates an example of a Vehicle 102 to which example implementations described in this disclosure can be applied. Vehicle 102 can, in various examples, be any moving platform that includes selectable modes for either driver-in-the-loop vehicle operation or autonomous vehicle operation.

Examples of possible vehicle platforms for Vehicle 102 include, but are not limited to: off-road recreational vehicles such all terrain vehicles (ATVs), side-by-side (S×S) vehicles, and utility terrain vehicles (UTVs); snowmobiles; motorcycles; commercial and personal on-road vehicles; heavy equipment vehicles such as mining and construction vehicles; and military vehicles. In some examples, Vehicle 102 can be an internal combustion engine powered vehicle; in some examples, Vehicle 102 can be an electrical vehicle; in some examples, Vehicle 102 can be a hybrid vehicle.

In the illustrated example, Vehicle 102 includes a number of on-board systems, including but not limited to, Perception System 104, Vehicle Operation Subsystems 106, including an anti-roll bar control system, Vehicle control sub-systems 106, a Driver Interface System 110, and a Vehicle sensor system 112. Each embodiment described in this disclosure is provided merely as an example or illustration of the present invention, and should not necessarily be construed as preferred or advantageous over other embodiments. In some instances, well known methods, procedures, objects, and circuits have not been described in detail as not to unnecessarily obscure aspects of the present disclosure.

FIG. 1A also shows, in dashed lines, an electronically controllable anti-sway roll bar system 100 that can be controlled by anti-roll bar control module 107. Although the anti-sway roll bar system 100 can be implemented using a number of different configurations, an illustrative configuration will now be described with reference to FIG. 1B, which can be controlled remotely to manipulate the stiffness of the anti-roll bar system. The stiffness of the anti-roll bar system 100 can be thought of as, for example, a driver's (or passenger's) perception of the “roll stability” of the vehicle 102. In other words, the perception of the driver (or passenger) of the vehicle 102 for the vehicle 102 to resist or allow “roll motion”. As one example, when riding in a vehicle (e.g., an S×S) vehicle) which appears to provide significant resistance to a rolling motion of the vehicle, it can be said that the vehicle has a “stiff” anti-roll bar system. As another example, when riding in a vehicle which appears to not provide significant resistance to a rolling motion of the vehicle, it can be said that the vehicle has a “soft” anti-roll bar system. It will be understood that a “soft” anti-roll bar system is desired in various conditions. For example, a soft anti-roll bar system provides better comfort during rock crawling and some slow driving activities. Further, it will be understood that “stiff” anti-roll bar system is desired in various conditions. For example, it will be understood that a stiff anti-roll bar system provides increased handling and control during high-speed cornering and various racing activities.

Further, in the following discussion, the term “active”, as used when referring to a damping component, means adjustable, manipulatable, etc., during typical operation of the component. For example, an active damping component of anti-roll bar system 100 can have its operation changed to thereby alter a corresponding damping characteristic from a “no” damping setting to a “full” damping setting by, for example, where “no” damping corresponds to a first mode in which a minimal degree of possible damping is provided and “full” corresponds to a second mode in which a maximum degree of possible damping is provided anti-roll bar system 100. “No” damping, i.e., the first mode, may correspond to the case where anti-roll bar system 100 is effectively operatively disengaged from performing any stabilization function, and “Full” damping, i.e., the second mode, may correspond to the case where the anti-roll bar system 100 is effectively fully engaged to its maximum stabilization function. In some examples, multiple discrete modes that each correspond to a different degree of damping (i.e., a plurality of levels of stiffness corresponding from very soft at “No” mode to very firm at “Full” mode).

In FIG. 1B, a perspective view of an anti-roll bar system 100 including an anti-roll bar 12 and two electronically controlled damper links, 14L and 14R, is shown in accordance with an illustrative, but non-limiting, embodiment. In various embodiments of anti-roll bar system 100, a first portion of electronically controlled damper link 14L includes a bushing, or similar coupling feature, to readily enable coupling of electronically controlled damper link 14L to, for example, a first end 13L of anti-roll bar 12. Similarly, in various embodiments of present anti-roll bar system 100, a first portion of electronically controlled damper link 14R includes a bushing, or similar coupling feature, to readily enable coupling of electronically controlled damper link 14R to, for example, a second end 13R of anti-roll bar 12. In various embodiments of present anti-roll bar system 100, a second portion of electronically controlled damper link 14L includes an eyelet, or similar coupling feature, to readily enable coupling of electronically controlled damper link 14L to a location on vehicle 102. Similarly, in various embodiments of present anti-roll bar system 100, a second portion of electronically controlled damper link 14R includes an eyelet, or similar coupling feature, to readily enable coupling of electronically controlled damper link 14R to a further location on vehicle 102.

Although the embodiment of FIG. 1B, depicts anti-roll bar system 100 having two electronically controlled damper links 14L and 14R, in another embodiment of the present invention, anti-roll bar system 100 includes only a single electronically controlled damper link (e.g., only 14L or only 14R). In such an embodiment, an electronically controlled damper link (e.g., 14L or 14R) is coupled to one end (e.g., a first end) of anti-roll bar 12, and, for example, a conventional end link is coupled to the other end (e.g., a second end) of anti-roll bar 12. Hence, anti-roll bar system 100 of the present invention is well suited to embodiments in which one end of anti-roll bar 12 has an electronically controlled damper link (e.g., 14L or 14R) coupled thereto, and also to embodiments in which both ends of anti-roll bar 12 have an electronically controlled damper link (e.g., 14L and 14R, respectively) coupled thereto. Additionally, for purposes of conciseness and clarity, portions of the following description may refer to an electronically controlled damper link as “electronically controlled damper link 14”, instead repeating the same description for each of electronically controlled damper link 14L and electronically controlled damper link 14R. It should be noted that such portions of the description are applicable to either electronically controlled damper link 14L or electronically controlled damper link 14R, as shown in anti-roll bar system 100 of FIG. 1A. Further, the present description will pertain to embodiments in which one end of anti-roll bar 12 has an electronically controlled damper electronically controlled damper link (e.g., 14L or 14R) coupled thereto, and also to embodiments in which both ends of anti-roll bar 12 have an electronically controlled damper link (e.g., 14L and 14R, respectively) coupled thereto.

The “stiffness” provided by anti-roll bar system 100 can be remotely controlled by controlling the stiffness or compliance of one or both of electronically controlled damper links 14L and 14R coupling anti-roll bar 12 to a vehicle. In example embodiments, the electronically controlled damper link 14 is connected by an electrical control link to anti-roll bar control module 107 to receive electrical control signals. In some examples, the control link can be provided by a conductive line or cable used to control an electronic valve within electronically controlled damper link 14 and, correspondingly, control the damping characteristics of electronically controlled damper link 14. Embodiments of the present anti-roll bar system 100 are also well suited to using a wireless signal (in addition to, or in lieu of, a physical control line) to control a valve or other component of electronically controlled damper link 14 such that, ultimately, the damping characteristic of electronically controlled damper link 14 is controllable.

In various embodiments, electronically controlled damper link 14L and electronically controlled damper link 14R are coupled to vehicle 102 at a location, for example, near a wheel or axle of vehicle 102 at respective left and right sides of vehicle 102. It will be understood that when the left and right sides of the suspension of vehicle 102 move relative to one another, anti-roll bar 12 of anti-roll bar system 100 is subjected to torsion and forced to twist. The twisting of anti-roll bar 12 will transfer forces between a heavily-loaded suspension side of vehicle 102 to the opposite, lesser-loaded, suspension side of vehicle 102.

In example embodiments, the different anti-sway bar system operating modes can be selected for electronically controlling damper link 14 to allow for fast acting, proportional changes to compression and/or rebound damping rates. Thus, electronically controlled damper link 14 replaces a conventional end link. Electronically controlled damper link 14 enables the stiffness or compliance of anti-roll bar system 100 to be remotely controlled by controlling the stiffness or compliance of electronically controlled damper link 14. For example, electronically controlled damper link 14 will, for example, increase its dampening, and, correspondingly, increase the stiffness of anti-roll bar system 100. In various embodiments of the present invention, such increased stiffness of anti-roll bar system 100 is advantageous, for example, during cornering, as vehicle speed rises, when vehicle roll is detected, and the like. Conversely, in various embodiments of the present invention, electronically controlled damper link 14 will, for example, decrease its dampening, and, correspondingly, decrease the stiffness of anti-roll bar system 100. In various embodiments of the present invention, such decreased stiffness of anti-roll bar system 100 is advantageous, for example, for rough terrain, slow speeds, rock crawling, and the like. In some examples, damper link may be substituted with a basic connect/disconnect link.

By way of example, FIG. 1C shows an example of an alternative form of an anti-roll bar system 100 wherein the electronically controlling damper links 14L, 14R are replaced with rigid portions 16L, 16R located at opposite ends of anti-roll bar 12. Anti-roll bar 12 includes a right portion and a left portion 12L, 12R that are mechanically coupled together by a single electrically controlled mechanical coupling device 15. The mechanical coupling device 15 functions as a basic connect/disconnect link in that it can be switched between a locked anti-roll mode (i.e., maximum degree of stiffness) wherein the right portion and left portions 12L, 12R of anti-roll bar 12 are rigidly coupled together and an unlocked roll-permissive mode (i.e., minimum degree of stiffness) wherein the right portion and left portions 12L, 12R can rotate relative to each other.

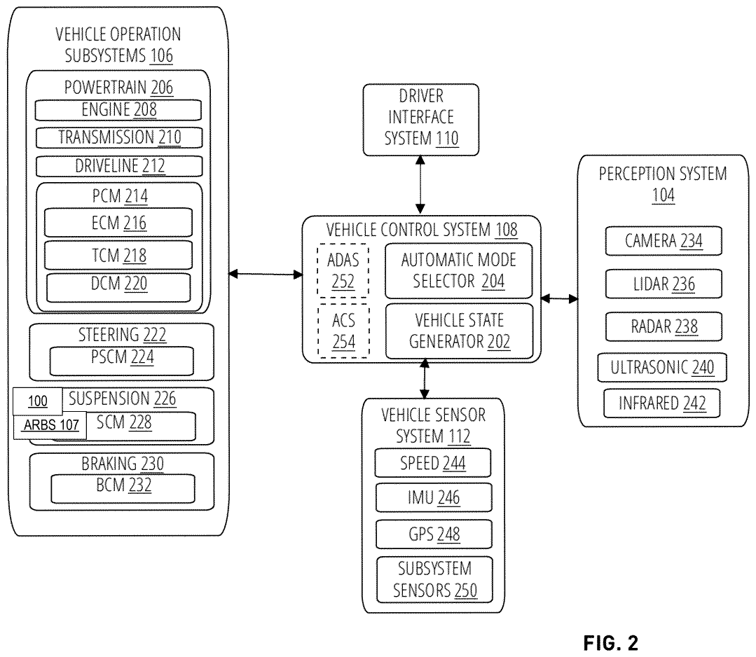

The integration of anti-roll bar system 100 and its corresponding control module 107 with other components of the vehicle 102 will now be described in greater detail with respect to FIG. 2, which illustrates examples of the on-board systems in greater detail, according to example embodiments.

in this regard, Perception System 104 includes one or more sensor systems that are designed to capture real-time perception data that represents the environment that the Vehicle 102 is operating within, including the environment in an intended direction of travel of the Vehicle 102. In example embodiments, the perception data can take the form of 2D or 3D image data that is represented, for example, as time-series of frames of pixels or point-cloud elements. Examples of sensor systems used to capture perception data can, for example, include: Visual light Camera(s) 234, LiDAR 236 (Light Detection and Ranging), Radar 238 (Radio Detection and Ranging), Ultrasonic 240, and Infrared 242.

Vehicle sensor system 112 includes a set of sensors for sensing operating conditions of the Vehicle 102 and its subsystems. The information collected by Vehicle sensor system 112 can be used to generate real-time vehicle state data 310. The Vehicle sensor system 112 can include sensors for collecting high level operating data about the vehicle, including a speed sensor 244 for sensing current vehicle speed, an IMU 246 (Inertial Measuring Unit) for measuring the vehicle's specific force, angular rate, acceleration and body orientation (pose) in 3 dimensions, and a satellite positioning system such as a GPS (Global Positioning System) receiver system 248 used to determine the vehicle's exact location. The Vehicle sensor system 112 can also include subsystem specific sensors 250 that are embedded in one or more of the Vehicle Operation Subsystems 106 for collecting subsystem specific operating condition data.

Driver Interface System 110 includes components that interface with a driver to receive driver inputs and provide feedback to the driver. Driver input components can, for example, include a steering input, throttle input and brake input components, as well as other input components such as a manual mode selection input.

Vehicle Operation Subsystems 106 includes subsystems of the vehicle that can be controlled to cause the Vehicle 102 to operate. By way of example, these subsystems can include Powertrain 206, Steering 222, Suspension 226 and Brake 230 systems. One or more of these subsystems can include further subsystems. For example, the Powertrain 206 includes all subsystems that provide power to the components (e.g., wheels) that propel the vehicle, including a power source 208 and a drivetrain (which includes, as further subsystems, a Transmission 210 and Driveline 212).

The Driveline 212 is a vehicle subsystem that distributes power from the power source and Transmission 210 to the wheels. While the exact components in Driveline 212 may vary depending on the design and configuration of the Vehicle 102 (e.g., front-wheel drive, rear-wheel drive, all-wheel drive, or four-wheel drive), they will typically include: (a) driveshaft, which transmits torque from the transmission to the differential for distribution to other driveline components; (b) differential(s), which transmits torque directly or indirectly to the wheels.; and (c) Axle shafts connect to either side of a differential and extend outward toward a respective wheel.

The Transmission 210 converts the energy generated by the power source into a power that can be distributed by the Driveline 212 to propel the vehicle. Common vehicle transmission types include manual transmissions, automatic transmissions and continuous variable torque (CVT) transmissions.

Other Vehicle Operation Subsystems 106 include Steering 222, Suspension 226 and Braking 230. In example implementations, anti-roll bar system 100 is part of suspension operation subsystem 106.

Vehicle Operation Subsystems 106 are typically controlled by respective control modules (also referred to as control units or electronic control units) that are embedded systems that control one or more of the electrical systems or subsystems in a vehicle. By way of example, in the illustrated example, the following control modules are illustrated:

Powertrain Control Module (PCM) 214: The PCM 214, which controls functions of the power source 208), Transmission 210 and Driveline 212 and may, for example be a combination of an Engine Control Module (ECM) 216, Transmission Control Module (TCM) 210 and Driveline Control Module (DCM) 220. The ECM 216 can, for example, in the case of a combustion engine power source manage engine performance by controlling fuel mixture, ignition timing, and variable valve timing, among other things. The TCM 218 controls the operation of the transmission, including gear shifting and torque converter clutch control. The DCM 220 controls operation of components of the Driveline 212, including for example the function of the differentials.

Power Steering Control Module (PSCM) 224: In vehicles with electronic power steering, the PSCM 224 controls the power steering motor to provide the appropriate level of steering assist and feedback.

Suspension Control Module (SCM) 228: In vehicles with adaptive suspension systems, the SCM 228 adjusts the suspension settings based on driving conditions.

In example embodiments, the anti-roll bar system 100 of suspension subsystem 226 is controlled by dedicated anti-roll bar system (ARBS) control module 107.

Brake Control Module (BCM) 232: This module controls the vehicle's braking system, including the anti-lock braking system (ABS) and, in some cases, the electronic stability control (ESC) system.

In the illustrated example, all of the systems and modules noted above are connected to communicate, directly or indirectly, with Vehicle control system 108. Vehicle control system 108 receives and processes data from Perception System 104, Vehicle sensor system 112, Driver Interface System 110 and Vehicle Operation Subsystems 106. Vehicle control system 108 processes the data it receives and provides feedback and commands to Vehicle Operation Subsystems 106 to cause the Vehicle 102 to function as intended. For example, in a driver-in-the-loop system, Vehicle Operation Subsystems 106 can include the processing systems required to interpret driver inputs received via the Driver Interface System 110 and provide corresponding instructions to the control modules of the Vehicle Operation Subsystems 106 such that the Vehicles 102 performs (e.g., accelerates, brakes, and turns) as instructed by the driver. In some examples, the Vehicle control system 108 can include an advanced driver assistance system (ADAS) 252 that can adjust or override driver inputs based on data from Perception System 104 and Vehicle sensor system 112. In some examples, Vehicle control system 108 can include an autonomous control system (ACS) 254 that can control Vehicle Operation Subsystems 106 based on data from Perception System 104 and Vehicle sensor system 112 without any driver input.

As noted above, the present disclosure is directed towards automatic mode selection, and in this regard, vehicle control system 108 is illustrated as including an Automatic Mode Selector 204. In example embodiments, Automatic Mode Selector 204 is a functional module that is implemented by a Computing System 702 (described in greater detail below) that includes a memory storing software instructions that, when executed by a processor of the Computing System 702, configure the Computing System 702 to perform the automatic mode selection functionality described herein.

As shown in FIG. 2, vehicle control system 108 can also include a Vehicle State Generator 202 that is configured to receive data about the sensed operating conditions of the Vehicle 102 and its subsystems from the Vehicle sensor system 112 and output corresponding real-time vehicle state data 310 for use by the other components of vehicle control system 108. By way of example real-time vehicle state data 310 can include a data structure or vector that includes, among other things, values for the following vehicle operating characteristics: vehicle speed, direction of travel, vehicle pose (e.g., pitch, yaw, roll); angular acceleration in 3 dimensions, linear acceleration, engine RPM, wheel slippage, braking and torque applied at wheels, steering angle, transmission gear, driveline state (e.g.: AWD; 4WD; 2WD; locked or unlocked differential(s)), driver inputs (steering, braking, throttle), suspension control state (including anti-roll bar system state (e.g., the current damping state of the electronically controlled damper link 14). The real-time vehicle state data 310 may, for example, be updated several times per second.

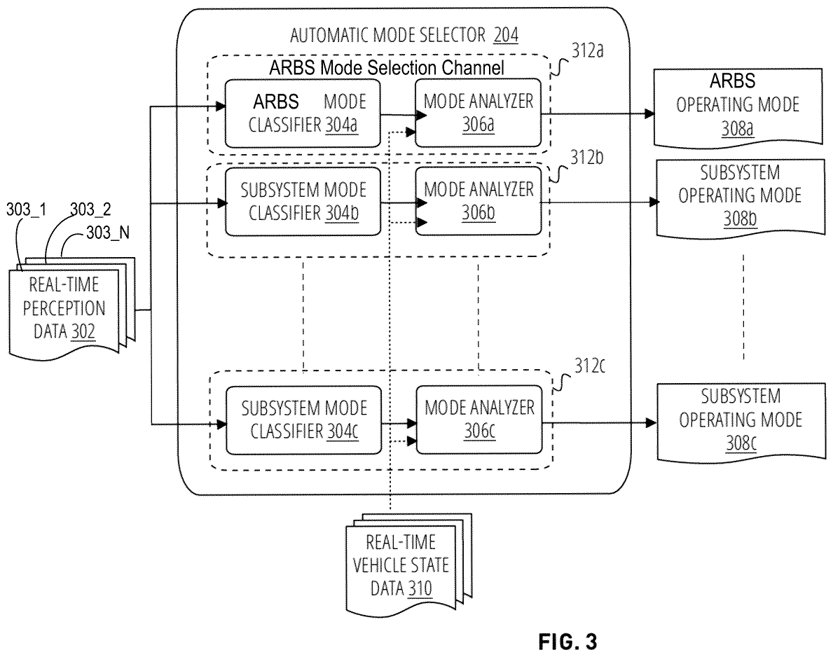

As noted above, example aspects of the present disclosure are directed towards systems and methods for performing of automatic mode selection. In this regard, Automatic Mode Selector 204 is shown in greater detail in FIG. 3. In one illustrated example, Automatic Mode Selector 204 operates in conjunction with, or is part of, ADAS 252. In such a scenario, Automatic Mode Selector 204 is configured to select a mode for anti-roll bar system 100 (and in some cases, other subsystems) and then cause the vehicle control system 108 to cause the selected mode to be applied by anti-roll bar system 100 (and any other relevant Vehicle Operation Subsystem(s) 106).

In some examples the automatic mode selector 204 can be configured to perform multiple subsystem mode selections in parallel, and in this regard can include multiple subsystem mode selection channels 312a, 312b, . . . , 312c each of which includes a respective Subsystem Mode Classifier 304a, 304b, . . . , 304c and Mode Analyzer 306a, 306b, . . . , 306c for outputting a respective Subsystem Operating Mode 308a, 308bc, . . . , 308c. Thus, the respective mode selection channels 312a, 312b, . . . , 312c can each receive the same inputs (real-time perception data 302 and real-time vehicle state data 310) but are each configured to predict and select modes for different subsystems of the vehicle. The frequency of outputted Subsystem Operating Modes 308a, 308bc, . . . , 308c can be different for each mode selection channel 312a, 312b, . . . , 312c.

In the illustrated example, the mode selection channel 312a is specifically configured to function as a model selection channel for anti-roll bar system 100, and as such the Subsystem Mode Classifier 304a has been trained to function as an anti-roll bar system (ARBS) mode classifier, and Mode Analyzer 306a is configured to function as an ARBS Analyzer for outputting a respective ARBS Mode 308a.

An example of mode selection for anti-roll bar system 100 of the Vehicle Operation Subsystems 106 will now be described in respect of ARBS mode selection channel 312a. In this regard, Automatic Mode Selector 204 is configured to receive, through one or more of the sensors of Perception System 104, real-time perception data 302 representing an environment in a direction of travel of the Vehicle 102. In a particular example implementation, Automatic Mode Selector 204 is configured to receive perception data 302 that takes the form of a single time series of 2D-image frames 303_1, 303_2, . . . , 303_N that are captured by a single 2D Visual light Camera 234. In such an implementation, the single 2D image data feed that is processed by Automatic Mode Selector 204 represents image data of the upcoming environment that the vehicle is travelling in, including for example images of the upcoming surface terrain. Limiting the perception data to a single 2D-image feed can, in at least some use cases, be advantageous in that the same Automatic Mode Selector 204 can be easily adapted for use on many different vehicle platforms as forward facing 2D-image cameras are commonly present on many vehicle platforms. Furthermore, machine learning (ML) based model processing of 2D images can be done in a computationally efficient manner, enabling Automatic Mode Selector 204 to be installed on vehicle-based computing systems that may have limited processing power and/or memory available to support ML based components.

The Automatic Mode Selector 204 also receives, through a Vehicle sensor system 112, real-time vehicle state data 310 indicating current operating characteristics of the Vehicle 102. The first-subsystem is associated with a set of predefined modes, and each of these predefined modes defines a respective set of one or more operating parameters for the first-subsystem. Automatic Mode Selector 204 includes ARBS Mode Classifier 304a, which is configured to map the real-time perception data to a candidate ARBS mode from the set of predefined modes. Automatic Mode Selector 204 also includes ARBS Mode Analyzer 306a that determines an ARBS mode based on the real-time vehicle state data and the first-subsystem candidate mode. The selected ARBS mode is then communicated to the ARBS control module 107 for real-time implementation.

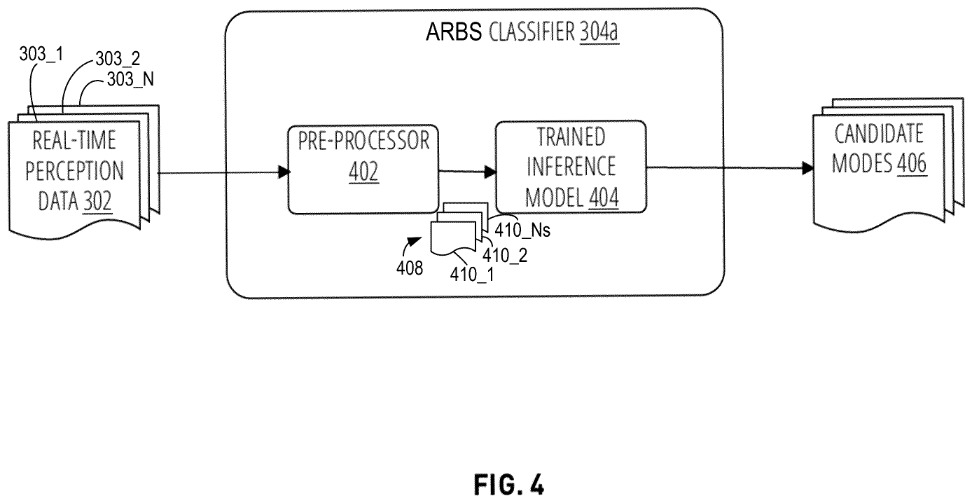

An example of ARBS Mode Classifier 304a is illustrated in FIG. 4. In the illustrated example, ARBS Mode Classifier 304a includes a pre-processor 402 and a fitted (e.g., trained) inference model 404. Pre-processor 402 is configured to perform any pre-processing activities (e.g., data fusion over multiple frames or from multiple sensors, filtering, camera lens correction, abstraction operations, and/or dimensionality reductions operations) that may be required to pre-condition real-time perception data 302 to put such data into a suitable condition for fitted inference model 404.

In one example implementation, pre-processor 402 of ARBS Mode Classifier 304a is configured to output pre-conditioned perception data 408 in respect of real-time perception data 302. In this regard, in one example, implementation, pre-processor 402 includes an image frame sampling operation to extract a subset of the 2D-image frames 303_1, 303_2, . . . , 303_N that make up real-time perception data 302. By way of example, in one possible scenario, the real-time perception data 302 that is obtained by the pre-processor 402 from Visual light Camera 234 consists of 60 image frames-per-second (FPS), with each image frame 303_i (i is used throughout this paper to denote a generic element within a set of elements) represented as a tensor having dimensions: width (columns)=1280 units, height (rows)=720 units, depth=3 units, the subject units are pixels, with each pixel indicating a measured light intensity value. The height and width dimensions correspond to respective 2D orthogonal spatial dimensions, and the depth dimensions correspond to respective color channels (e.g., RGB). Pre-processor 402 is configured to extract a subset of image frames from the perception data 302 at a specified sampling rate that can be pre-defined to optimize operation of its respective mode selection channel. For example, a different image frame sampling rate can be set for mode selection channel 312a than for mode selection channel 312a based on a required responsiveness for the mode that is the subject of the respective mode selection channel. By way of example, in one use case scenario, the sampling rate for the pre-processor 402 in respect of mode selection channel 312a may be set during system configuration to provide 10 FPS (i.e., 1 frame of every 6 frames of a 60 FPS video feed is extracted), while the sampling rate for the pre-processor 402 in respect of mode selection channel 312b may be set during system to provide 30 FPS (i.e., 1 frame of every 2 frames of a 60 FPS video feed is extracted). In at least some implementations, the sampling rate for the pre-processor 402 can also be dynamically set based on real-time operating characteristics of the vehicle indicated in the vehicle state data 310. For example, a faster sampling rate may be applied as vehicle speed increases.

In an illustrated example, ARBS Mode Classifier 304a is further configured to resize and crop the extracted subset of Ns frames. By way of example, in one possible scenario, the width 1280, height=720, depth=3 of each extracted frame is resized to width=400, height=225, depth=3 by combining sub-groups of pixels in the width and height dimensions of each channel using a standard resizing algorithm. The resized image frames are then cropped by performing a center crop operation to extract the central 225 columns of each resized image frame, resulting in a square image frame of width=225, height=225, depth=3. In at least some examples, the resulting reduced-dimension square image frames 410_1, 410_2, . . . , 410_Ns can be processed by mode analyzer 306a using fewer computational resources than would be required by the original uncropped larger size images, without adversely impacting prediction accuracy. In at least some examples, the pre-processor 402 is configured to perform dimensionality reduction operations (such as resizing and cropping) that are pre-defined to optimize operation of its respective mode selection channel. In some examples, the extracted image frames may be further preprocessed to convert the 3 color channels into a single grey-scale channel.

Fitted inference model 404 is a machine learning (ML) based model that has been fitted to predict a future mode for the first-subsystem based on the upcoming environment that is represented in the pre-conditioned perception data 408. Fitted inference model 404 can for example include a convolution neural network (CNN) that is configured by learned parameters to perform a classification operation in respect of the input pre-processed perception data 408 to classify the perception data 408 as belonging to a selected category (i.e., a candidate mode) from a set of possible categories (i.e., a set of predefined modes that the first-subsystem can operate in). In the case of ARBS classifier 304a, as noted above, in the case the set of ARBS modes can include at least a first candidate mode and a second candidate mode, where the first candidate mode may correspond to the case where anti-roll bar system 100 is effectively operatively disengaged from performing any stabilization function, and the second candidate mode may correspond to the case where the anti-roll bar system 100 is effectively fully engaged to its maximum stabilizing effect. In some examples, set of ARBS modes can include one or more discrete intermediate modes that each correspond to a different degree of damping (i.e., each of the intermediate modes corresponds to respective level of stiffness between the first mode (e.g., “maximum softness” or “no damping”) to the second mode (“maximum stiffness” or “full damping”).

In some examples, fitted inference model 404 is configured to generate respective candidate mode predictions 406 at a rate of between 5 to 20 mode predictions per second. This prediction rate is illustrative only, and slower or faster rates (e.g., 30 mode predictions per second) may be used in different implementations depending on the hardware and software used to implement the systems of Vehicle 102. In the example implementation where the pre-conditioned perception data 408 consists of image frames 410_1, 410_2, . . . , 410_Ns, the fitted inference model 404 is configured to generate a respective candidate mode prediction 406 for each of the image frames 410_1, 410_2, . . . , 410_Ns. In an example implementation, fitted inference model 404 can be a computational and memory resource light model that can run on a computational device that has limited processing and memory resources. A non-limiting example of such a CNN model is the ShuffleNet V2 model [See: Ningning Ma, Xiangyu Zhang, Hai-Tao Zheng, Jian Sun; ShuffleNet V2: Practical Guidelines for Efficient CNN Architecture Design; arXiv: 1807.11164v1, 2018].

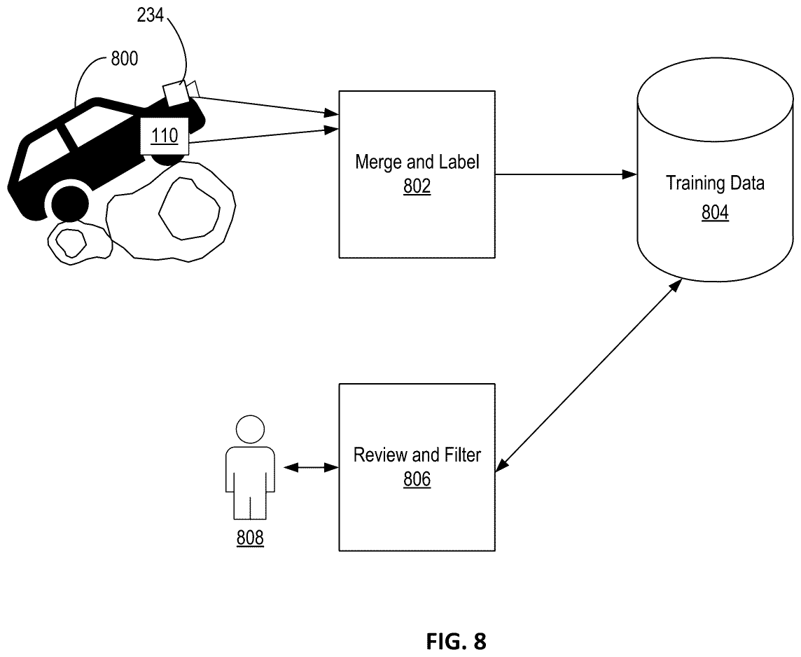

In example embodiments, the fitted inference model 404 is an artificial learning based model that has been trained based on a labeled training dataset acquired by monitoring manual mode inputs of an expert driver of a training vehicle and associating the mode inputs with perception data captured by the perception system of the training vehicle contemporaneously with the mode inputs as the test vehicle is driven by the expert driver through multiple test environments that are representative of all intended uses of the vehicle. By way of example, FIG. 8 illustrates a process for obtaining a set of labelled training data 804 for training a fitted inference model 404. In the example of FIG. 8, a professional driver drives a vehicle 800 that can be operated in multiple modes for one or more types of modes (for example, multiple driveline modes and/or multiple suspension modes). During operation of the vehicle 800, the driver manually selects different modes using a driver interface system 110, which is configured to record and timestamp the mode selections as they occur. Simultaneously, a forward facing 2D video camera 234 affixed to the vehicle 800 records times stamped image frames of the upcoming terrain. The recorded and timestamped mode selections and the recorded and timestamped image frames are provided to a computer hosted merge and label function that auto-labels the image frames by tagging each image frame with a label corresponding to the respective mode selection at the time the image frame was captured, providing labelled training data 804. In at least some examples, the raw image frames may be conditioned processed by applying the same mode-type specific resizing and cropping operations as discussed above in respect of pre-processor 402, so that image frame included in labelled training data 804 have the same dimensionality as the image frames that the trained inference model 404 will be processing in real-time operation. In at least some example embodiments, all image frames obtained from the image feed provided by video camera 234 are auto-labelled (e.g., all frames in a 60 FPS feed) in order to maximize the number of training images.

In some example implementations, the auto-labelled image frames included in training data 804 are selected for quality review by either an automated or manual review and filter process 806. For example, computer-implemented review and filter process 806 can be configured to remove outlier image frames that do not meet specified training image criteria. For example, images that are occluded by debris on a camera lens or a passing branch or other non-terrain-relevant object may be removed from the training dataset 804 to provide a higher quality training dataset. In some examples, review and filter process 806 can include a user interface that enables a human reviewer 808 to visually inspect image frames and delete image frames that do not meet quality criteria. In some examples, review and filter process 806 can be configured by a rules-based or machine learning based model to automatically review and filter our image frames that don't meet training image criteria. In some examples, this automated review can be used to pre-filter image frames that are then selectively presented to a human reviewer 808 to confirm that the selected image frames should be discarded or kept.

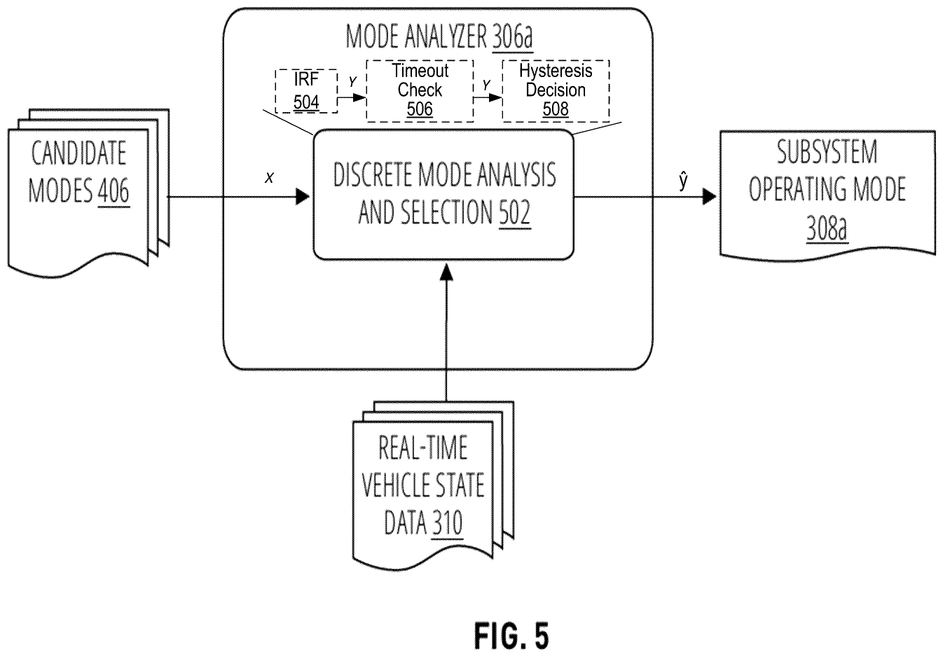

With reference to FIG. 5, the candidate modes predictions 406 predicted by Fitted inference model 404 are provided to Mode Analyzer 306a. The Mode Analyzer 306a is configured to assess, based on the real-time vehicle state data, the appropriateness of the candidate modes to filter out modes that are not appropriate for real-time implementation by the anti-roll bar system 100. The Mode Analyzer 306a selects an appropriate ARBS mode that is then communicated to the anti-roll bar control module 107 for implementation.

In the example of FIG. 5, Mode Analyzer 306a performs discrete mode analysis and selection 502. The Mode Analyzer 306i for each respective mode selection channel 312i can be uniquely configured for the mode prediction task that is performed by that channel. As noted above, fitted inference model 404 can, in some examples, generate respective candidate mode prediction 406 predictions at a rate of between 5 to 20 or more mode predictions per second. However, discrete mode selection and implementation may, for at least some mode channels, be performed at a much slower rate that can be subsystem (e.g., mode channel) dependent. For example, in some scenarios ARBS Mode Analyzer 306a will output an updated first-subsystem operating mode 308a every 2 seconds to 3 seconds. In some examples, Mode Analyzer 306a may be configured to output an updated operating mode 308a multiple times per second.

In a first example, ARBS Mode Analyzer 306a will perform preliminary mode selection based on sampling the candidate modes that are included in a time series set of ARBS candidate mode predictions 406. For example, the ARBS Mode Analyzer 306a can be configured to select an ARBS candidate mode that has appeared a threshold number of times within a preceding number of time steps in the candidate mode predictions 406. By way of example, a mode that has appeared as a candidate mode in greater than 80% of the candidate mode predictions for a 5 second duration can be selected as a preliminary mode selection.

In some scenarios, subsystem specific criteria can then be applied to determine the appropriateness of the preliminary mode selection, including the following: (1) compatibility of preliminary mode selection with the mode that is currently being applied by the ARBS (e.g., in some scenarios it may not be possible to switch directly from one mode to another mode without first going through one or more intermediate modes); (2) time duration since the current mode was selected and implemented (e.g., in some scenarios, excessive mode switching may be problematic); and (3) compatibility of the preliminary mode selection with one or more current vehicle state 310 characteristics (e.g., some mode changes may be deemed unsafe or inappropriate if a speed or other operating characteristic exceeds or otherwise does not meet some predefined threshold).

If the preliminary mode selection is determined to be appropriate, the ARBS Mode Analyzer 306a selects the preliminary mode selection as the ARBS mode and causes that mode to be provided to the ARBS module 107 for implementation by the anti-roll bar system 100. If the preliminary mode selection is determined to be not appropriate it is rejected and is not provided for implementation. The ARBS Mode Analyzer 306a then continues on with preliminary selection and analysis of a further mode based on the next time-series of predicted modes.

In at least some examples, the subsystem specific criteria applied to determine the appropriateness of the preliminary mode selection for a subsystem (e.g., for anti-roll bar system 100) may exclude some of the criteria categories noted above. For example, the subsystem specific criteria could be based on one or both of: (1) compatibility of preliminary mode selection with the mode that is currently being applied by the subsystem and (2) time duration since the current mode was selected and implemented (e.g., in some scenarios, excessive mode switching may be problematic), without specifically considering compatibility of the preliminary mode selection with one or more current vehicle state 310 characteristics. In such scenarios, the current vehicle state 310 as sensed by the vehicle sensor system 112 is not required for automatic mode selection.

An alternative operation of ARBS mode analyzer 306a according to a second example implementation will now be described. In an example embodiment, discrete mode analysis and selection 502 functions as a decider that includes the following set of operations: (1) an impulse response filtering operation (IRF) 504; (2) a timeout check operation 506; and, optionally, (3) a hysteresis decision operation 508. Among other things, these operations collectively filter the candidate mode predictions 406 output by inference model 404 to enable meaningful control signals to be applied to the relevant vehicle operation subsystems 106 that are associated with the subject control mode.

Impulse response filtering (IRF) operation 504 will now be described in greater detail. In an example embodiment, each candidate mode prediction 406 output by inference model 404 can be represented as a probabilities vector (e.g., a Softmax classification vector {X∈ [symbol] |∥X∥=1}, where n is the number of candidates modes for the mode selection channel 312a, and each element x in the n dimensional vector X=[x_₁, x_₂, . . . x_ₙ] represents the probability of a respective candidate mode. IRF operation 504 filters the candidate mode predictions 406 using an impulse response filter, which could for example be an Infinite Impulse Response (IIR) filter or a Finite Impulse Response (FIR) filter depending upon the mode selection task.

In the example where an IIR filter implementation is applied, a Transposed-Direct-Form-II (TDF-II) structure can be used, as represented by the following equation:

$$Y = {b}_{0} X + {\sum }_{i = 1}^{k} ( {b}_{i} {X}_{i} - {a}_{i} {Y}_{i} )$$

where:
Y is the filtered candidate mode probabilities vector Y=[y_₁, y_₂, . . . y_ₙ], output by the IIR filter;
k is the order of the filter.
b₀, bᵢ and aᵢ and are coefficients chosen during the design of the filter (e.g., low-pass with a set cut-off frequency).
Xi are the past mode predictions 406 made by the inference model 404, i.e., X₁ is the last probabilities vector before the current inference model output, X₂ the second last and so on.
Yi are the past output vectors of the IIR filter itself i.e., Y₁ is the last filtered probabilities vector output before the current output, Y₂ the second last and so on.

In example implementation, coefficients bᵢ and aᵢ are defined to provide a low-pass filter with a defined cut-off frequency (e.g., 10 Hz). Thus, Impulse response filtering (IRF) operation 504 controls a rate at which candidate modes are provided to downstream operations.

In the case where a FIR filter implementation is applied, the Direct-Form-II (TDF-II) structure can be used, as represented by the following equation in which the variables each have the same meanings as noted above:

$$Y = {b}_{0} X + {\sum }_{i = I}^{k} {b}_{i} {X}_{i}$$

Timeout check operation 506 will now be described in greater detail. The timeout check operation 506 is performed to check if enough time has passed since the last time that a change occurred in the ARBS operating mode 308a output by the ARBS mode analyzer 306a. The objective of Timeout check operation 506 is to provide sufficient time for the vehicle operation subsystems 106 that are affected by the mode selection to successfully apply the changes to the vehicle and/or improve the experience of the occupants (for example, constant changes to driveline or suspension settings can be uncomfortable due to noise and vibration). In this regard, ARBS mode analyzer 306a is configured to record a “last mode change” time whenever a new ARBS operating mode 308a output by the ARBS mode analyzer 306a. Timeout check operation 506 is configured to compare a current time with the recorded “last mode change” time to a defined time criteria, for example a minimum time threshold. If the elapsed time since the last subsystem operating mode change meets or exceeds the minimum time threshold, the mode analysis and selection 502 then proceeds to the hysteresis decision operation 508. In the event that the elapsed time since the last subsystem operating mode is less than the minimum time threshold, the mode analysis and selection 502 proceeds back to IRF operation 504 to process an updated set of incoming candidate modes 406 without outputting a new operating mode 308a. In at least some example implementations, the minimum time threshold parameter is uniquely set for each respective mode selection channel 312i. In some examples, timeout check operation 506 may be configured to adapt the minimum time threshold within a defined range based on the real-time vehicle state data 310. For example, the minimum time threshold may decrease as vehicle speed increases, thereby enabling mode changes to occur more frequently at higher speeds.

Hysteresis decision operation 508 will now be explained in greater detail. This operation implements an heuristic to dynamically add a delay to the implementation of a candidate mode from the mode probabilities vector Y based on a hierarchy level defined for the changes between the candidate modes that are controlled by a mode selection channel 312i. For example in the case of the anti-roll bar system 100, when the vehicle 102 is about to exit a “Maximum Softness” mode appropriate terrain and enter into a “Maximum Stiffness” mode appropriate terrain, the trained inference model 404 will be already predicting that the anti-roll bar system 100 should switch to “Maximum Stiffness” mode at a time at which some wheels of the vehicle would still be inside a “Maximum Softness” area. If a mode change is implemented before the vehicle 102 is fully out of the “Maximum Softness” area, driver/passenger discomfort could occur. If the situation is reversed and the vehicle is about to exit a “Maximum Stiffness” area into a “Maximum Softness” area, then an early change will not cause any problem. Thus, when changing from “Maximum Softness” to “Maximum Stiffness” mode, a higher delay (hysteresis) is desirable than when changing in the opposite direction. This is accomplished by defining a hysteresis vector {H E R″}, where n is the number of candidate modes, for the hysteresis decision operation 508. In this regard, hysteresis decision operation 508 processes the following data to select a candidate mode 308a for implementation. (1) the current filtered candidate mode selection probabilities vector Y=[y_1, y_2, . . . y_n] generated by the (IRF) operation 504; (2) a hysteresis vector H=[h_1, h_2, . . . h_n] that includes a respective hysteresis element corresponding to each candidate mode; (3) the candidate probability y_jlast selected associated with the last selected mode 308a (i.e., the mode that is currently being applied by vehicle 102), where j∈{1, 2, . . . , n); and (4) the hysteresis element h_jlast selection value that was applied during the selection of the candidate probability y_jlast selected. Hysteresis decision operation 508 computes a difference between the value of each of the current filtered candidate mode selection probabilities vector Y=[y_1, y_2, . . . y_n] and the probability y_jlast selected associated with the last selected mode 308a to obtain the set of difference values [y_1−y_jlast selected, y_2−y_jlast selected, . . . , y_n−y_jlast selected].

Each of the candidate mode-specific difference values are then compared to the value of the hysteresis element h_jlast selection from hysteresis vector H=[h_1, h_2, . . . h_n] that corresponds to the last selected mode 308a. If one or more of the candidate mode-specific difference values has a greater value than the value of the hysteresis element h_jlast selection, then the candidate mode that is associated with the highest candidate mode-specific difference value is selected as the candidate mode decision and output as the next ARBS operating mode 308a. In the event that none of the candidate mode-specific difference values has a greater value than the value of the hysteresis element h_jlast selection, the hysteresis decision operation 508 does not output an ARBS operating mode 308a and instead moves on to process an updated set of filtered candidate modes Y in the real-time data stream. Thus, for each filtered candidate mode selection represented in probabilities vector Y Hysteresis decision operation 508 determines a difference between the probability computed for each of the candidate modes and the probability value generated in respect of the last ARBS operating mode 308a output by the mode analyzer 306a. If the highest difference (e.g., distance) computed is also higher than the hysteresis value that corresponds to the previously selected mode then the mode element that generated the highest difference is selected and output as the ARBS operating mode 308a. In at least some example implementations, the values of the elements of hysteresis vector {HϵR\hat{ }n}, are set based on data recorded during expert driver acquisition of data for the training data 804. In at least some examples, the values of hysteresis vector {HϵR\hat{ }n} can be set at different values based on the current real-state vehicle state data 310. For example, the hysteresis values may decrease as vehicle speed increases, thereby reducing delays in mode changes at higher speeds.

Examples of specific mode selection scenarios in respect of anti-roll bar will now be described.

TABLE 1
ARBS modes

| Mode ID | Operating Parameters |
|---|---|
| Maximum | Damper Link set to no damping |
| Softness | |
| Moderately Soft | Damping link set to 25% damping |
| Middle | Damping link set to 50% damping |
| Moderately | Damping link set to 75% damping |
| Stiff | |
| Maximum | Damping link set to full damping |
| Stiffness | |

In one example, the case of Driveline 212, the mode selection channel 312a is configured to process real-time perception data 302 and real-time vehicle state data 310 to automatically select which of the five possible ARBS modes should be implemented by the anti-roll bar system 100 to optimize vehicle performance. In this regard, real-time perception data 302 provides information about the upcoming terrain that will be experienced over the next several seconds by the Vehicle 102, including for example image data about the upcoming surface terrain (e.g., upcoming changes in terrain altitude or height and surface condition (snow, ice, water, mud, rock). In at least some examples this information can be indicative of respective conditions at multiple surface contact points (i.e., each of the four wheels) of the Vehicle 102. With reference to FIG. 4 Pre-processor 402 of the ARBS Mode Classifier 304a pre-processes real-time perception data 302 into a format suitable for fitted inference model 404. In the illustrated example, fitted inference model 404 has been trained based on a training dataset obtained through real-life tracking of ARBS mode selections made by an expert driver through all terrain and driving conditions examples that Vehicle 102 can be reasonably expected to experience.

Fitted inference model 404 maps the on-going pre-processed real-time perception data to a respective time-series set of ARBS candidate mode predictions 406. Each ARBS candidate mode prediction 406 corresponds to one of the five possible modes identified in Table 1. In some examples, the candidate mode predictions 406 are predicted at a rate of 5 to 15 per second. With reference to FIG. 5, the candidate mode predictions 406 are provided to ARBS Mode Analyzer 306a for discrete mode analysis and selection 502. In some examples, ARBS Mode Analyzer 306a selects a preliminary mode based on a sampling of the set of candidate mode predictions 406 based on predefined sampling criteria (e.g., the most common mode in the last 3 seconds). The preliminary mode selection is then evaluated based on predefined appropriateness criteria (e.g., rules that define: what ARBS modes can be performed in succession; how often the ARBS mode can be changed; if current vehicle speed (or other defined characteristics represented in vehicle state data 310) are suitable for the preliminary mode selection to be implemented. In the event that the analysis indicates that the preliminary mode selection is appropriate, the preliminary mode selection is output as a new ARBS Operating Mode 308a and is provided by the vehicle control system 108 to ARBS control module 107 that provides a control signal to electronically controlled damper link 14 (e.g., one or both of links 14A and 14B) for implementation as the mode for an upcoming time period until a new replacement mode is provided. In the event that the analysis indicates that the preliminary mode selection is not appropriate, the preliminary mode selection is discarded and the anti-roll bar system will continue in the previously instructed mode.

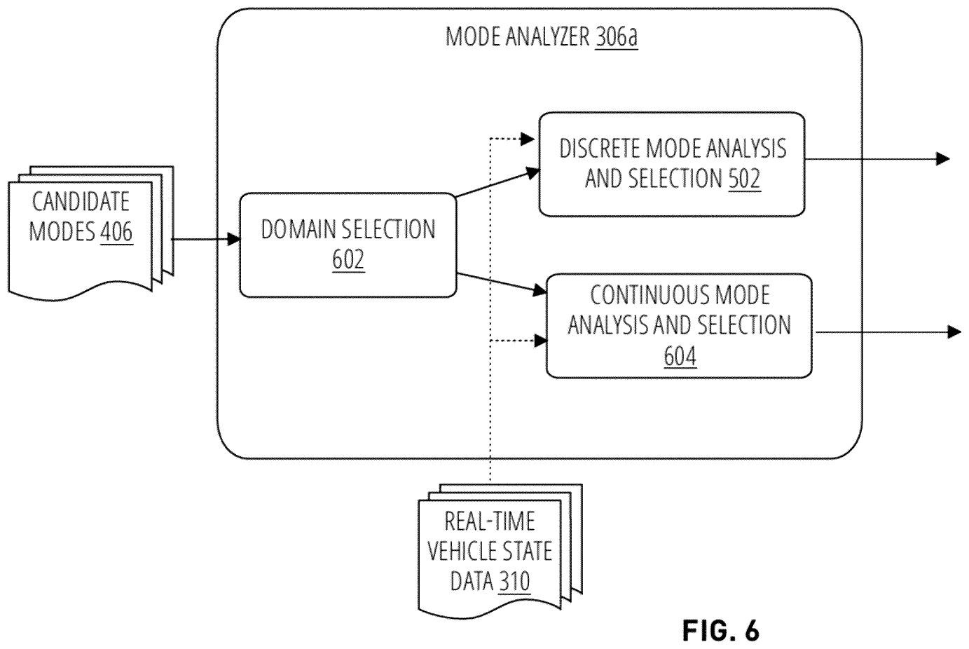

In some example embodiments one or more of the mode selection channels (for example mode selection channel 312a) can be configured to function in a discrete domain as described above, or alternatively in a continuous domain. By way of example, FIG. 6 illustrates an alternative example of Mode Analyzer 306a that can be selectively configured to operate in a discrete mode selection domain by applying discrete mode analysis and selection operation 502 as described above, or alternatively, in a continuous mode selection domain by applying continuous mode analysis and selection operation 604 to candidate mode predictions 406. Rather than providing discrete subsystem mode outputs, the continuous mode analysis and selection operation 604 is configured to output an ongoing time series of subsystem settings at a higher rate (e.g., rather than a discrete mode of 10 Hz, or larger durations such as every 5 to 10 seconds, updated subsystem settings may be output at a higher frequency (i.e., effectively continuous) rate. Thus, the continuous domain can provide faster-rate, finer control of subsystem operating parameters.

In some examples the Mode Analyzer 306a includes a domain selecting component 602 for selecting discrete domain or continuous domain mode section options. In some examples the domain selecting component 602 may be controlled by a user input or predetermined rules. In some examples it may be pre configured for discrete domain or continuous domain mode section depending on a factory or installation setting based on the type of subsystem that the modes will be applied to.

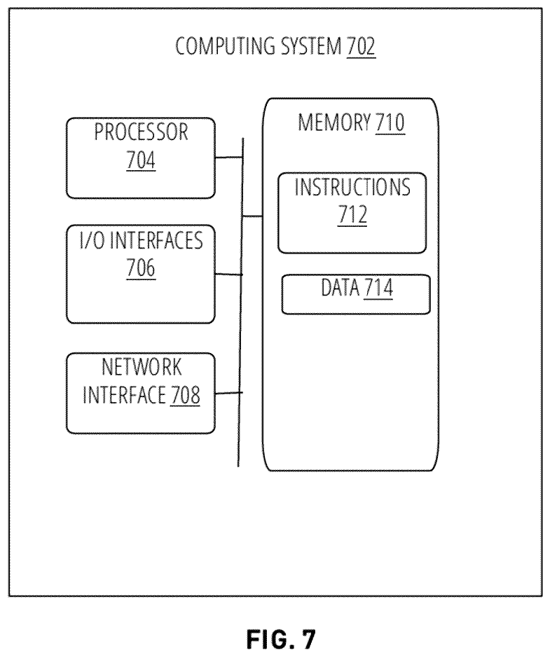

With reference to FIG. 7, in at least some examples the automatic mode selector 204 and other computer implemented components of Vehicle 102 can be implemented by one or more Computing Systems 702 that are embedded in Vehicle 102. Computing System 702 can, for example, include one or more Processors 704, I/O Interfaces 706, Network Interfaces 708, Memory(ies) 710, Instructions 712, and Data 714. In example embodiments, Memory 710 includes non-transient memory storing Instructions 712, and Data 714 that when executed by the one or more Processors 704 cause the Computing System 702 to implement automatic mode selector 204 and possibly other control components of the Vehicle 102

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The contents of all publications referenced in this disclosure are incorporated by reference.

The terms “substantially” and “approximately” as used in this disclosure mean that the recited characteristic, parameter, or value need not be achieved exactly, but that deviations or variations including for example, tolerances, measurement error measurement accuracy limitations and other factors known to those skilled in the art, may occur in amounts that do not preclude the effect the characteristic was intended to provide. In some examples, the terms “substantially” and “approximately”, can mean a range of within 10% of the stated characteristic.

What is claimed is:

1. A computer implemented method for automatically controlling a stabilization of a vehicle, comprising:
receiving, through a video camera of the vehicle, real-time perception data comprising a sequence of image frames representing an environment in a direction of travel of the vehicle;
predicting, using a trained inference model, based on the sequence of image frames, a sequence of anti-roll bar system mode predictions for an anti-roll bar system of the vehicle, wherein the anti-roll bar system candidate mode predictions correspond to a set of predefined modes for the anti-roll bar system;
determining, based on the sequence of anti-roll bar system mode predictions, an anti-roll bar system mode; and
causing the anti-roll bar system mode to be implemented.

2. The method of claim 1 wherein determining the anti-roll bar system mode comprises:
filtering the sequence of anti-roll bar system candidate mode predictions to identify a possible anti-roll bar system mode prediction; and
selecting the anti-roll bar system mode based on the possible anti-roll bar system mode prediction.

3. The method of claim 2 wherein each of the anti-roll bar system candidate mode predictions comprises a candidate mode probabilities vector that includes a respective probability value for each of the predefined modes for the anti-roll bar system,
wherein filtering the predicted sequence of anti-roll bar system candidate mode predictions comprises applying an impulse response filter to the sequence of anti-roll bar system candidate mode predictions, the output of the impulse response filter comprising the possible anti-roll bar system mode prediction.

4. The method of claim 3 wherein the filtering is based on a most recent prediction in the sequence of anti-roll bar system candidate mode predictions, past predictions in the sequence of anti-roll bar system candidate mode predictions and past possible anti-roll bar system mode predictions output by the filtering.

5. The method of claim 3 wherein filtering applies low pass filtering to the sequence of anti-roll bar system candidate mode predictions.

6. The method of claim 3 wherein determining the anti-roll bar system mode further comprises performing a time check to confirm that a time threshold has passed since a last anti-roll bar system mode was caused to implemented, and when the time threshold has not passed, causing the receiving, predicting and determining to be repeated without causing the anti-roll bar system mode to be implemented by the anti-roll bar system.

7. The method of claim 3 further comprising receiving, through a vehicle sensor system, real-time vehicle state data indicating current operating characteristics of the vehicle, wherein at least one of a filtering rate used for the filtering and a rate used for extracting the subset of image frames, is based on a vehicle speed included in the real-time vehicle state data.

8. The method of claim 1 wherein the trained inference model is a fitted model dedicated to predicting anti-roll bar system modes, the method further comprising pre-training the trained inference model, the pre-training comprising:
obtaining a time-stamped sequence of image frames captured by a forward-facing camera video camera of a test vehicle during operation of the test vehicle by an expert driver;
obtaining a time-stamped sequence of mode inputs performed by the expert driver contemporaneously with the capturing of the image frames;
merging the sequence of the image frames and the mode inputs to provide a set of labelled training image frames; and
training a convolution neural network based on the labelled training image frames to obtain the trained inference model.

9. The method of claim 1 wherein determining the anti-roll bar system mode comprises:
identifying, based on the sequence of anti-roll bar system candidate mode predictions, a possible anti-roll bar system mode that is appropriate for real-time implementation by the anti-roll bar system; and
confirming that the possible anti-roll bar system can be applied as the anti-roll bar system mode based on a time duration since a most recently implemented anti-roll bar system candidate mode; and
identifying the possible anti-roll bar system candidate mode that is appropriate comprises confirming that the real-time implementation will meet specified vehicle criteria, wherein the vehicle criteria specifies one or more operating constraints at which the anti-roll bar system candidate mode can be implemented, the operating constraints including one or more of a maximum speed, operating state of one or more other vehicle subsystems, and a direction of travel.

10. The method of claim 1 wherein the anti-roll bar system comprises:
a controller;
an anti-roll bar;
an electronically controlled link responsive to control signals from the controller for implementing the anti-roll bar system modes;
wherein the anti-roll bar, the electronically controlled link, and the vehicle are collectively configured such that a degree of stiffness applied by the anti-roll bar between opposite side wheel supports of the vehicle is adjusted based on the control signals, the anti-roll bar system modes including at least a first mode wherein a minimal degree of stiffness is applied and a second mode wherein a maximum degree of stiffness is applied.

11. The method of claim 10 wherein the electronically controlled link can be selectively controlled by the control signals to apply multiple degrees of stiffness corresponding to respective anti-roll bar system modes, and the anti-roll bar system modes include a plurality of intermediate modes between the first mode and second mode, each mode corresponding to a different degree of stiffness being applied.

12. The method of claim 11 wherein the anti-roll bar has a first end and a second end,
the first end being coupled by the electronically controlled link to a first location of the vehicle, the electronically controlled link comprising a damper having a remotely controllable valve for adjusting damping characteristics of the damper, the remotely controllable valve controllable based upon the control signals; and
the second end coupled to a second location of the vehicle by a second link.

13. The method of claim 10 wherein the anti-roll bar has a first portion having a first end and a second portion having a second end, the first end being coupled to a first location of the vehicle, the second end coupled to a second location of the vehicle, the electronically controlled link including a mechanical coupling device that couples the first portion of the anti-roll bar to the second portion of the anti-roll bar, wherein in the first mode the mechanical coupling device is in an unlocked state such that the minimal degree of stiffness is applied and in the second mode the mechanical coupling device is in a locked state such that the maximum degree of stiffness is applied.

14. A vehicle comprising:
an anti-roll bar system comprising an anti-roll bar, an electronically controlled link responsive to control signals for implementing anti-roll bar system modes,
the anti-roll bar and the electronically controlled link being collectively configured and operatively coupled to the vehicle such that a degree of stiffness applied by the anti-roll bar between opposite side wheel supports of the vehicle is adjustable based on the control signals between a minimal degree of stiffness and a maximum degree of stiffness;
a computer system, the computer system being configured for automatically selecting an operating mode of the anti-roll bar system by:
receiving, through a video camera of the vehicle, a sequence of image frames representing upcoming terrain in a direction of travel of the vehicle;
predicting, using a first fitted inference model, based on the sequence of image frames, a sequence of candidate mode predictions for the anti-roll bar system, wherein the candidate mode predictions correspond to a set of predefined modes for anti-roll bar system, the set of predefined modes including at least a first mode corresponding to the minimal degree of stiffness and a second mode corresponding to the maximum degree of stiffness;
determining, based on the sequence of candidate mode predictions, an anti-roll bar system mode; and
causing an appropriate control signal to be applied to the electronically controlled link to cause the anti-roll bar system to implement the anti-roll bar system mode.

15. The vehicle of claim 14 wherein the anti-roll bar system modes include a plurality of intermediate modes between the first mode and second mode, each mode corresponding to a different degree of stiffness being applied.

16. The vehicle of claim 14, wherein determining the anti-roll bar system mode comprises:
filtering the sequence of candidate mode predictions to identify a possible anti-roll bar system mode prediction; and
selecting the anti-roll bar system mode based on the possible anti-roll bar system mode predictions.

17. The vehicle of claim 16 wherein each of the candidate mode predictions comprises a candidate mode probabilities vector that includes a respective probability value for each of the predefined anti-roll bar system modes,
wherein filtering the sequence of candidate mode predictions comprises applying an impulse response filter to the sequence of candidate mode predictions, the output of the impulse response filter comprising the possible anti-roll bar system mode prediction.

18. The vehicle of claim 17 wherein the filtering is based on a most recent prediction in the sequence of candidate mode predictions, past predictions in the sequence of candidate mode predictions and past possible anti-roll bar system mode predictions output by the filtering.

19. The vehicle of claim 14 wherein the anti-roll bar has a first end and a second end,
the first end being coupled by the electronically controlled link to a first location of the vehicle, the electronically controlled link comprising a damper having a remotely controllable valve for adjusting damping characteristics of the damper, the remotely controllable valve controllable based upon the control signals; and
a second end coupled to a second location of the vehicle by a second link.

20. The vehicle of claim 14 wherein the set of predefined modes consist of only the first mode corresponding to the minimal degree of stiffness and the second mode corresponding to the maximum degree of stiffness, and
the anti-roll bar has a first portion having a first end and a second portion having a second end, the first end being coupled to a first location of the vehicle, the second end coupled to a second location of the vehicle, the electronically controlled link including a mechanical coupling device that couples the first portion of the anti-roll bar to the second portion of the anti-roll bar, wherein in the first mode the mechanical coupling device is in an unlocked state such that the minimal degree of stiffness is applied and in the second mode the mechanical coupling device is in a locked state such that the maximum degree of stiffness is applied.
